(19) United States
(12) Patent Application Publication
(10) Pub. No.: US 2006/0047886 A1
(43) Pub. Date: Mar. 2, 2006

(54) Memory controller

(76) Inventor: Peter Leaback, London (GB)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/202,938

(22) Filed: Aug. 12, 2005

(30) Foreign Application Priority Data
Aug. 25, 2004 (GB) GB 0418970.0

(51) Int. Cl. G06F 12/00

(52) U.S. Cl. 711/5; 711/202

(57) ABSTRACT

A memory controller maps a processor generated address to a banked DRAM address by applying a randomising function which results in the banks appearing in an irregular and non-cyclic order in the conceptual memory map. Incremental addressing by two or more requestors is thereby more evenly distributed amongst the banks of DRAM to improve average access speed.

### CROSS REFERENCE TO RELATED APPLICATIONS

The present application claims the benefit of Great Britain Patent Application No. GB 0418970.0 filed on Aug. 25, 2004, which is incorporated herein by reference.

### FIELD OF THE INVENTION

This invention relates to a memory controller for controlling access to a Random Access Memory (RAM) device and in particular to a memory controller for random bank allocation of a banked RAM device. The invention is particularly suitable for addressing a banked Dynamic RAM (DRAM) device. The method and apparatus have particular application for use with processors running a wide range of applications including 3-d graphics applications and in particular for operations such as reading bit-maps from memory and reading lists of polygons to be rendered.

### BACKGROUND OF THE INVENTION

Main memory for computers is commonly provided by Dynamic Random Access Memory (DRAM) devices. Each DRAM device consists of a large array of memory capacitors which are arranged in rows and columns. To operate on a memory location in the array a control circuit calculates the row of the location, places the row address on the DRAM's address pins and toggles the address select (RAS) pin causing the DRAM to read the row address. The DRAM connects the selected row to the sense amplifiers. The control circuit then calculates the column of the location, places the column address on the DRAM's address pins, and toggles the Column Address Select (CAS) pin causing the DRAM to read the column address which it uses to select the output of the sense amplifier corresponding to the selected column. Once the control circuit has selected a first row, it can select several columns from the first row by successively placing different column addresses on the address pins and toggling the CAS whilst keeping the first row selected. The resulting access time for successive operations is reduced and the technique is particularly useful for accessing data stored at successive addresses in memory. Hence, access times for addressing further columns in the same row (page) are shorter than access times for addressing a new page. When banking is used, the address of a location in DRAM also incorporates a bank address specifying the bank. Fastest access times are possible when the bank and row addresses are kept constant from one access to the next. If the row address (page) is altered and the bank address kept constant, slowest access results. If the row address is altered and the bank address is simultaneously altered, there is potential for the access speed to be somewhere between the slowest and fastest access time. Hence when implementing a DRAM addressing system for banked DRAM, it is advantageous to arrange the system such that when a row address is changed, the bank address is likely to change simultaneously. Fast-page access mode is only available if the page can be kept open between memory accesses and a bank is only able to keep one page open for fast-page access. Therefore, a page in a bank can only be kept open if the next memory access to that bank is to another location within the open page or if the next memory access is to a different bank. The restrictions of fast-page access mean that it is only possible to swap between requestors without any access speed slow down if the requestors are each accessing an open page. Known memory organisations for banked memory include high-order interleave, low-order interleave and some intermediate order interleave systems. A memory system using high-order interleave uses the high order address bits to select a particular bank of memory. Thus, the address bits which specify the bank are placed at the top of the memory map and the bank contains a block of consecutive addresses. Conceptually, the N banks appear as blocks of memory utilising 1/N of the address space each. When used with DRAM it makes particular sense to use the intermediate P bits of the processor generated address to address the row (page) of the DRAM and the least significant R bits of the processor generated address as the column address of the DRAM. FIG. 1 shows schematically how the conceptual memory map is organised with the banks each occupying ¼ of the address space and the pages occupying 1/(N-1) of each bank. The column address (not shown in the schematic) would be used to specify a particular column of a page. If multiple processors, or requesters, each use a different bank of memory, all the banks can transfer data simultaneously. When the number of requesters exceeds the number of banks of memory, it becomes difficult to assign requestors to banks to ensure that access speeds are maximised. Assuming four banks specified using 2 bank bits, row addresses of 12 row bits and column addresses of 8 column bits, a high-order interleave system, or most significant bit (msb) addressing mode, would have an address map as follows:
AddressMap=Bank[1 downto 0]& Row[11 downto 0]& Column[7 downto 0]
   where & is the VHDL concatenate operator.

In a low-order interleave system, consecutive addresses are placed in alternate banks by using the least significant address bits to specify the bank. A requestor therefore needs to access more than one of the banks as it executes its program or transfers data. When low-order interleave is employed, reading a number of consecutive locations in the memory map cycles through the same number of banks and hence one requestor may effectively lock open a page for each bank preventing other requestors from achieving fast memory access. Low-order interleave can, therefore, result in a memory conflict if two requestors request simultaneous access to the same bank of memory.

Intermediate-order interleave systems can also be designed. By designing an appropriate intermediate-order interleave system, it is possible for a number of requestors each to keep a page open as long as the pages map into different banks. For a memory arranged into N banks, it is possible for N requestors each to have a page open in one of the N banks and hence intermediate-order interleave can be particularly useful in a system with a plurality of requesters. For DRAM with banking, a particularly useful address map is one in which the most significant bits specify the row (page) address, the intermediate bits specify the bank address and the least significant bits specify the column address. This type of interleaving, which we term least significant bit (1sb) addressing, places consecutive addresses in the same bank for a whole page, then changes bank at the end of the page. FIG. 2a shows schematically how the conceptual memory map is organised with the pages each occupying 1/(N-1) of the address space and the banks occupying ¼ of each page. The column address (not shown in the schematic) would be used to specify a particular column of a page in a particular bank. The order that the banks appear in the conceptual memory map is the same for each page in 1sb addressing. When 1sb addressing is used, instead of carefully trying to place requesters in different banks, the aim is to randomise the placement of requestors in banks.

For example consider the 1sb addressing mode where the most significant P bits of the address map are used to specify the row address, the next most significant Q bits of the address map are used to specify the bank address and the least most significant R bits are used to specify the column address. Assuming a four bank system requiring Q=2 bank bits, and row and column addresses having respectively P=12 row bits and R=8 column bits, the memory map will cycle through the four banks (0,1,2,3) every 32KB (assuming an 8KB row (or page)). The conceptual address map for the 1sb addressing mode is:
AddressMap=Row[11 downto 0] & Bank[1 downto 0]& Column[7 downto 0]

This intermediate-order interleave system is designed to change bank each page which helps to ensure fast access speeds.

### SUMMARY OF THE INVENTION

We have appreciated that a problem with 1sb addressing is that there is at least one common memory access pattern that results in a slow overall memory access speed due to the need to access consecutively different row addresses in the same bank. This can occur when more than one requester (processor, device or the like) requires access to consecutive addresses in the memory, a second requestor likewise requires access to consecutive addresses in the memory and both requestors happen to require access to the same bank. As the two requestors increment the addresses they are accessing, the location being addressed in the DRAM repeatedly falls in the same bank and the access time is maximised resulting in poor overall performance.

We have appreciated that this problem is due to the cyclic nature of the order that the banks appear in the conceptual memory map. By memory map we mean the table that relates processor generated addresses arranged in ascending or descending order to a corresponding row, bank and column address of a banked RAM device. By “conceptual” we mean that the conceptual memory map may never physically exist as a look-up table, list or the like; a row, bank and column address may be generated on-the-fly by applying a suitable mapping function to processor generated address. We have appreciated that by substantially randomising the order in which the banks appear in the conceptual memory map, the problem can be ameliorated. By randomising the order in which the banks appear in the conceptual memory map we mean arranging the conceptual memory map such that the order of the banks at a first row (page) address is randomly different from that at a second and subsequent row addresses. Although the order of banks may have to be repeated for more than one page (assuming the number of banks to be small compared to the number of pages) the random way in which the bank order is repeated means that two requestors consecutively addressing the memory and happening to address the same bank at one stage in the addressing are unlikely to continue sequentially to access the same bank as they increment their addressing.

The invention is defined in the claims to which reference is now directed.

### BRIEF DESCRIPTION OF THE FIGURES

FIG. 1 is a schematic showing high-order interleave applied to a banked memory;

FIG. 2a is a schematic showing an intermediate-order interleave applied to a banked memory;

FIG. 2b is a schematic showing the randomised least significant bit addressing mode applied to a banked memory in accordance with the invention;

FIG. 3 is schematic diagram of a computer system in accordance with the invention;

FIG. 4 is schematic flow-chart showing mapping of the processor generated address to a bank, row and column address in accordance with a preferred embodiment of the invention; and

FIG. 5 is a schematic diagram showing in more detail the configuration of the memory controller in accordance with a preferred embodiment of the invention.

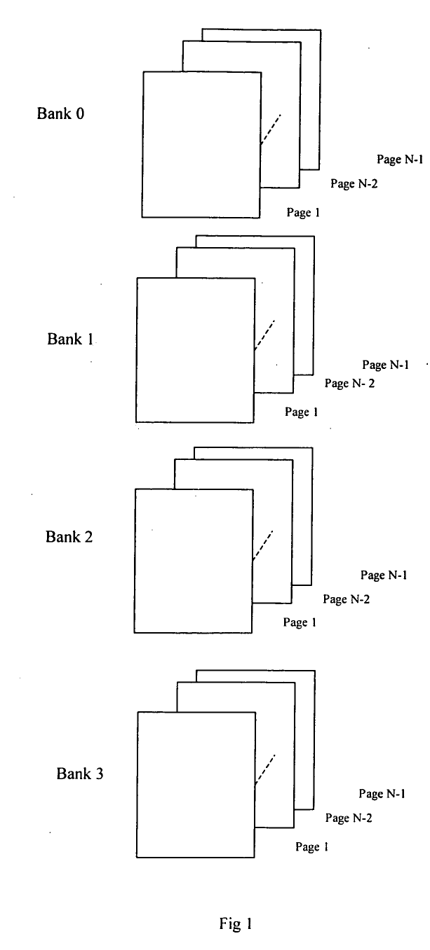

### DESCRIPTION OF A PREFERRED EMBODIMENT

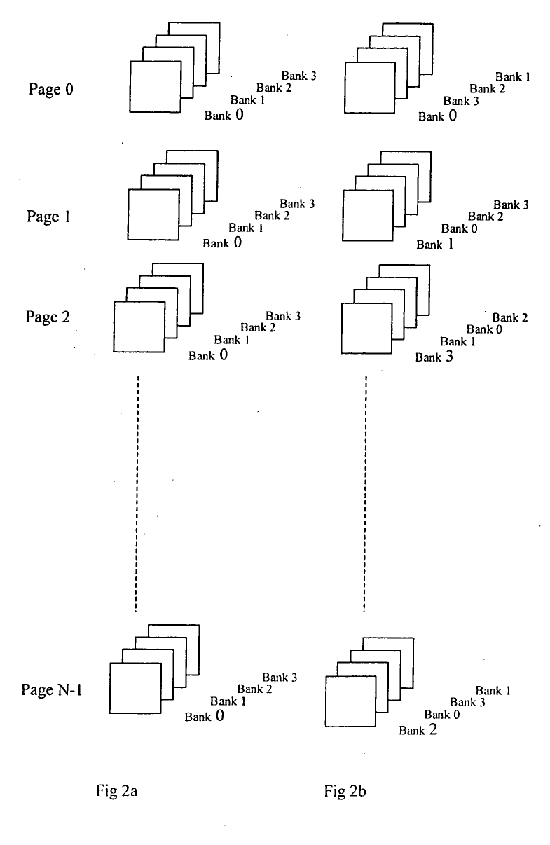

The invention is based on the appreciation that by using intermediate-order interleaving and forcing the order of the banks in the conceptual memory map to be irregular and non-cyclic, the average access speed of memory can be improved for a multiple requestor computer system. We term this randomised 1sb addressing. FIG. 2b shows schematically how the conceptual memory map is organised with the highest order bits specifying the row (page) address and each page occupying 1/(N-1) of the address space, the next most significant bits specifying the bank with each bank occupying ¼ of each page address space. The column address (not shown in the schematic) would be used to specify a particular column of a page. Of particular note is the fact that the order that the banks appear is random and hence differs between pages.

It will be immediately apparent to the skilled man that any number of randomising functions could be used to implement randomised 1sb addressing. Any function which, when applied, maps the bits used to specify the bank in an uncorrelated manner so that the result is a random order of banks in the conceptual memory map would meet the requirements of the randomised 1sb addressing scheme. In the presently preferred embodiment, a portion of the processor generated address is used to generate the randomising function.

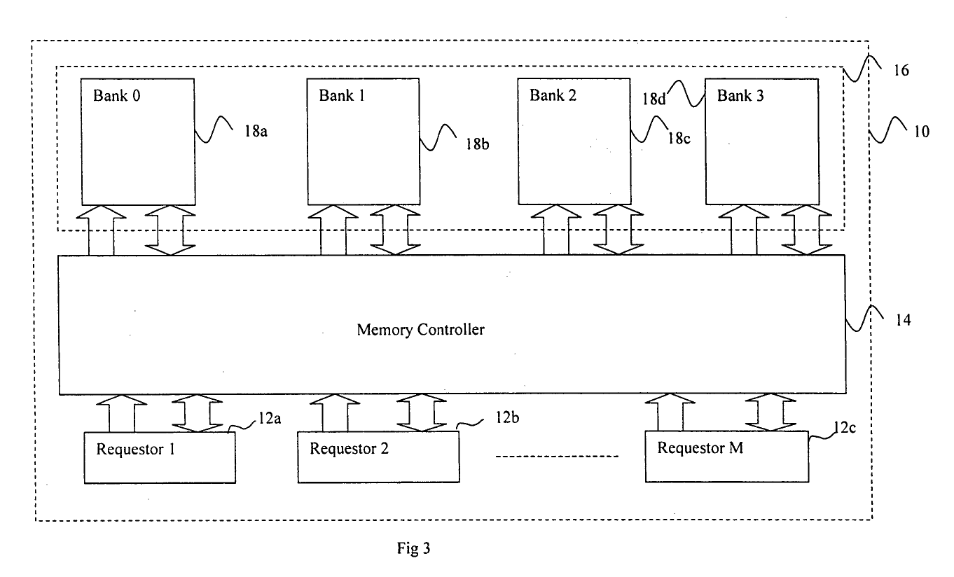

FIG. 3 shows a computer system 10 comprising a plurality of requestors 12a, 12b, . . . 12c, a memory controller 14 and a memory 16 comprising four banks of DRAM 18a, 18b, 18c and 18d. The requesters 12 are coupled to the memory controller 14. The requestors 12 may be separate processors or devices. The requesters 12 input processor generated addresses to the memory controller 14 and may transfer data to memory or receive data from memory via the memory controller 14. The memory controller 14 is coupled to each of the banks of DRAM 18a, 18b, 18c and 18d and outputs DRAM addresses comprising row, bank and column addresses to the DRAM. The memory controller 14 may receive data from a DRAM bank or cause data to be written to a DRAM bank. The timing and addressing protocols required for reading from and writing to a DRAM device are provided by the memory controller 14 and are not discussed here in detail. A function of the memory controller 14 is to take a processor generated address and map it into a DRAM address by applying a randomising function which results in the banks appearing in an irregular and non-cyclic order in the conceptual memory map. Incremental addressing by two or more requesters is thereby more evenly distributed amongst the banks of RAM to improve average access speed by reducing conflicts generated when two separate processors attempt to access the same bank but a different row of DRAM.

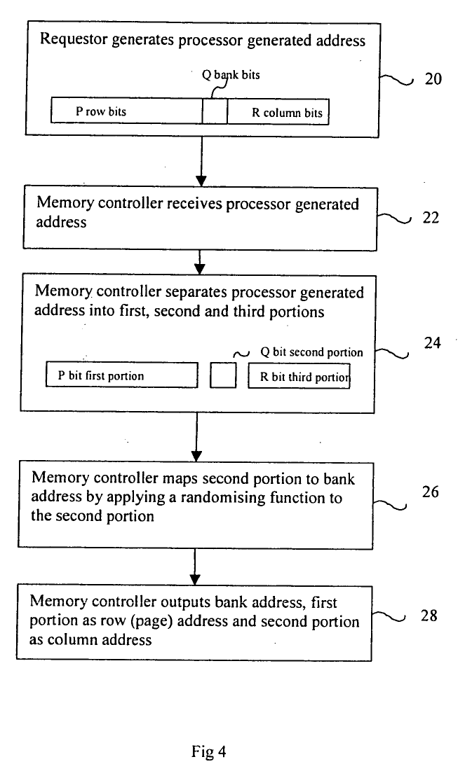

FIG. 4 is a flowchart showing a preferred method of mapping the processor generated address into bank, row and column addresses for the banked DRAM. A requestor generates a processor generated address 20. The memory controller receives the processor generated address 22 and separates the processor generated address into three portions, the first portion relating to the row address, the second portion relating to the bank and the third portion relating to the column address 24. The P most significant bits of the processor generated address are used as the first portion and are directly used to specify the row address of DRAM. In the presently preferred embodiment, P=12 and the twelve most significant bits of the processor generated address are used as the row address. The third portion is formed by taking the R least significant bits of the processor generated address. In the presently preferred embodiment the eight least significant bits of the processor generated address are used directly as the column address of DRAM. In order to achieve the randomisation of the bank order in the conceptual memory map, the intermediate Q bits (that is the Q next most significant bits after the P most significant bits of the processor generated address) are used to generate a bank address to select the bank of DRAM. In the presently preferred embodiment, there are four banks of DRAM and Q=2. The memory controller 14 is configured to map the second portion to a bank address by applying a randomising function to the second portion 26, the application of the randomising function having the effect of randomising the order in which the banks occur in the conceptual memory map relating the addresses generated by the processor to the addresses of the RAM device. The memory controller outputs the bank address, row (page) address and column address 28 in accordance with the timing and addressing protocols required by the particular DRAM device.

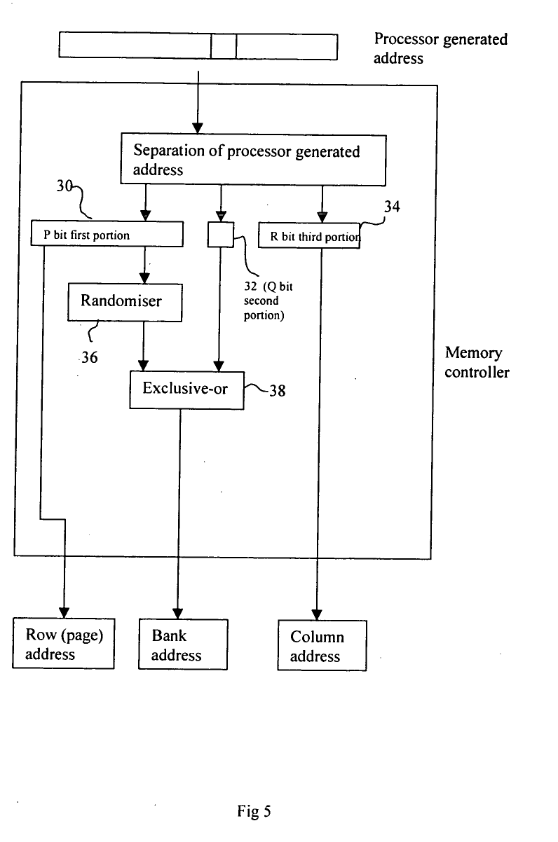

In the presently preferred embodiment, the bank address is formulated using both the bits of the processor generated address used to specify the row and also the Q next most significant bits (or bank bits of the processor generated address). The R bit third portion 34 is used as the column address and is not used in the randomising function in the presently preferred embodiment. FIG. 5 shows schematically more detail of the configuration of the memory controller 14. The bits used for specifying the row (the most significant P bits of the processor generated address) 30 are taken and applied as an input to a randomiser 36. The randomiser 36 maps the input to an uncorrelated, but reproducible, output producing a randomising function. In the presently preferred embodiment, the randomiser 36 is based on the “Lucifer” encryption system and is basically a cascade of 4 bit lookup tables and exclusive-or gates. The steps performed by the randomiser 36 are (i) taking each nibble of the input word and putting them through one of two 4-bit look-up tables, (ii) XORing the results of the look-up tables and (iii) XORing the top 2 bits of the result with the bottom 2 bits. A suitable randomiser may be implemented by the following C code:

UINT32 SboxRandSimple(UINT32 Seed)
{

UINT32 Sbox0[]={12, 15, 7, 10, 14, 13, 11, 0, 2, 6, 3, 1, 9, 4, 5, 8};
UINT32 Sbox1[]={7, 2, 14, 9, 3, 11, 0, 4, 12, 13, 1, 10, 6, 15, 8, 5};
UINT32 Stage1 [8];
UINT32 Stage2;
UINT32 Result;
Stage1[0]=Sbox0[Seed & 0xF];
Stage1[1]=Sbox1[(Seed>> 4) & 0xF];
Stage1[2]=Sbox0[(Seed>> 8) & 0xF];
Stage1[3]=Sbox1[(Seed>> 12) & 0xF];
Stage1[4]=Sbox0[(Seed>> 16) & 0xF];
Stage1[5]=Sbox1[(Seed>> 20) & 0xF];
Stage1[6]=Sbox0[(Seed>> 24) & 0xF];
Stage1[7]=Sbox1[(Seed>> 28) & 0xF];
Stage2=Stage1[0]\hat{ }Stage1[1]\hat{ }Stage1[2]\hat{ }Stage1[3]

\hat{ }Stage1[4]\hat{ }Stage1[5]\hat{ }Stage1[6]\hat{ }Stage1[7]:

Result=(Stage2 & 3) \hat{ } (Stage2 >> 2);
return(Result);

}

The randomising function is applied by supplying the output of the randomiser 36 as one of two inputs to an exclusive-or gate 38, the second input to the exclusive-or being the Q bank bits of the processor generated address 32. The output of the exclusive-or 38 is used as the bank address to select the bank. The resulting order of banks in the conceptual memory map is substantially randomised. For example, with four banks the order may be of the type [0 3 2 1], [1 0 2 3], [3 1 0 2] and so on in a substantially non-repeating, irregular way. This fulfils the requirement that the order in which the banks appear in the conceptual memory map is irregular and prevents the cyclic ordering which can result in slow memory access.

The conceptual address map for the randomised 1sb addressing mode is shown schematically in FIG. 2b and can be expressed as:

AddressMap=Row[11 downto 0] & Bank[randomised function of first and second portions of the processor generated address] & Column[7 downto 0]

Whilst the mapping of the bank bits to a bank address has been described in terms of a hardware solution, the mapping could be implemented in software. For example, a look up table could be used in which the most significant bits of the processor generated address (relating to the row address) could be used to access a row of the look up table and the next most significant bits to access a column of the table which would yield a bank address which met the required random order criterion. Other software and/or hardware implementations are within the implementation abilities of the skilled man.

With respect to the above description, it is to be realised that equivalent apparatus and methods are deemed readily apparent to one skilled in the art, and all equivalent apparatus and methods to those illustrated in the drawings and described in the specification are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. It should be noted that features described at different points of the description may be used in combinations other than those particularly described or shown.

1. A computer system comprising a processor, a banked random access memory (RAM) device and a memory controller, the memory controller being coupled to the processor and to the banked random access memory device and being configured to map an address generated by the processor to a RAM address specifying a bank, row and column of a memory location in the RAM device, wherein the memory controller is configured to:
a) receive a processor generated address;
b) separate the processor generated address into a first portion relating to a row, a second portion relating to a bank, and a third portion relating to a column;
c) use the first portion and third portion respectively as the row and column addresses of the RAM device;
d) map the second portion to a bank address by applying a randomising function to the second portion, application of the randomising function having the effect of substantially randomising the. order in which the banks occur in the conceptual memory map relating the addresses generated by the processor to the addresses of the RAM device;
e) output the row, bank and column addresses to the RAM device.

2. A computer system according to claim 1, wherein the memory controller is configured to use the P most significant bits of the processor generated address as the first portion, the Q next most significant bits of the processor generated address as the second portion and the R least significant bits of the processor generated address as the third portion.

3. A computer system according to claim 1, wherein the memory controller is configured in hardware.

4. A computer system according to claim 1, wherein the memory controller is configured in software.

5. A computer system according to claim 1, wherein the banked RAM device is banked DRAM.

6. A computer system according to claim 1, wherein the memory controller is configured to use the processor generated address to generate the randomising function.

7. A computer system according to claim 6, wherein the memory controller is configured to use part of the processor generated address to generate the randomising function.

8. A computer system according to claim 7, wherein the memory controller is configured to use the first portion of the processor generated address to generate the randomising function.

9. A computer system according to claim 1, wherein the memory controller is configured to apply the randomising function by performing an exclusive-or operation on the randomising function and the second portion of the processor generated address.

10. A memory controller for mapping an address generated by a processor to a RAM address, the memory controller being configured to:
(i) receive an address from a processor, the address relating to a portion of memory to be accessed;
(ii) separate the address into a first portion relating to a row address of a RAM device, a second portion relating to a bank address of a RAM device, and a third portion relating to a column address of a RAM device;
(iii) map the second portion to a bank address by applying a randomising function to the second portion, application of the randomising function having the effect of substantially randomising the order in which the banks of the RAM device occur in the conceptual memory map relating the addresses received from the processor to the memory location to be accessed in the RAM device;
(iv) output to a RAM device the first portion as a row address, the third portion as a column address and the mapped second portion as a bank address.

11. A memory controller according to claim 10, configured to use the P most significant bits of the processor generated address as the first portion, the Q next most significant bits of the processor generated address as the second portion and the R least significant bits of the processor generated address as the third portion.

12. A memory controller according to claim 10, configured to use the processor generated address to generate the randomising function.

13. A memory controller according to claim 12, configured to use part of the processor generated address to generate the randomising function.

14. A memory controller according to claim 13, configured to use the first portion of the processor generated address to generated the randomising function.

15. A memory controller according to claim 10, configured to apply the randomising function by performing an exclusive-or operation on the randomising function and the second portion of the processor generated address.

16. A method of accessing a memory location in a RAM device configured as a plurality of banks, each bank comprising an array of rows and columns, the method comprising the steps of:
a) receiving a first address generated by a processor;
b) separating the first address into a first portion relating to a row, a second portion relating to a bank, and a third portion relating to a column;
c) using the first portion and third portion respectively as the row and column addresses of the RAM device;
d) mapping the second portion to a bank address by applying a randomising function to the second portion, the application of the randomising function having the effect of substantially randomising the order in which the banks occur in the conceptual memory map relating the addresses generated by the processor to the RAM device addresses;
e) accessing the memory location of the RAM device identified by the row, bank and column addresses.

17. A method according to claim 16 wherein step (b) is performed on a first address of length (P+Q+R) bits and comprises performing the following operations in any order:
(i) separating the P most significant bits of the first address to form the first portion;
(ii) separating the intermediate Q bits of the first address to form the second portion, the intermediate Q bits being located in the first address between the P most significant bits and R least significant bits; and
(iii) separating the R least significant bits of the first address to form the third portion.

18. A method according to claim 16, further comprising the steps:
f) receiving a second address generated by a second processor;
g) separating the second address into a first portion relating to a row, a second portion relating to a bank, and a third portion relating to a column;
h) using the first portion and third portion respectively as the row and column addresses of the second processor access to RAM device;
i) mapping the second portion generated in step (g) to a bank address for the second processor access to RAM device by applying a randomising function to the second portion, the application of the randomising function having the effect of substantially randomising the order in which the banks occur in the conceptual memory map relating the addresses generated by the processor to the RAM device addresses;
e) accessing the memory location of the RAM device required by the second processor and identified by the row, bank and column addresses generated in steps (f) to (j), whereby when the first and second processors successively increment the first and second addresses the likelihood of the same bank being repeatedly addressed by both processors is reduced.

19. A method according to claim 16, wherein the randomising function is generated using the processor generated address.

20. A method according to claim 19, wherein the randomising function is generated using part of the processor generated address.

21. A method according to claim 20, wherein the randomising function is generated using the first portion of the processor generated address.

22. A method according to claim 16, wherein the randomising function is applied to the second portion by performing an exclusive-or operation on the randomising function and the second portion of the processor generated address.
